(19) United States
(12) Patent Application Publication
(10) Pub. No.: US 2023/0184192 A1
(43) Pub. Date: Jun. 15, 2023

(54) TURBOMACHINE EXHAUST CASE

(71) Applicant: SAFRAN AIRCRAFT ENGINES, Paris (FR)

(72) Inventors: Romain Harold Patrice POU, Moissy-Cramayel (FR); Frédéric DAUTREPPE, Moissy-Cramayel (FR)

(73) Assignee: SAFRAN AIRCRAFT ENGINES, Paris (FR)

(21) Appl. No.: 17/925,406

(22) PCT Filed: May 7, 2021
(86) PCT No.: PCT/FR2021/050784

§ 371 Date: Nov. 15, 2022

(30) Foreign Application Priority Data
May 15, 2020 (FR) 2004873

(51) Int. Cl. F02K 1/28; F01D 17/12; F02C 6/08; F02K 1/38; F02K 1/46

(52) U.S. Cl. CPC F02K 1/28; F01D 17/12; F02C 6/08; F02K 1/38; F02K 1/46; F05D 2220/32; F05D 2230/60; F05D 2240/12

(57) ABSTRACT

The invention relates to an exhaust case (15) for a turbomachine extending along a longitudinal axis (X), comprising: an annular shroud (23) having a wall (24) extending along the longitudinal axis (X) from a first flange (25), a plurality of openings (27) being provided through the wall (24); a plurality of mouths (28) each forming a channel (29) extending upstream to downstream between a respective inlet (30) and one of the openings (27), each mouth (28) having: a docking flange (31) at the inlet (30) having a radially inner edge (32) which is in contact with the first flange (25) of the annular shroud (23), a mouth wall (34) delimiting the channel (29) and comprising a radially inner wall portion (35) which is formed by a thickened section made on the wall (24) of the shroud (23).

### GENERAL TECHNICAL FIELD

The invention relates to the field of turbomachines, and more precisely of turbomachine exhaust cases and the methods for manufacturing same.

### DESCRIPTION OF THE PRIOR ART

A turbomachine 1, such as illustrated in FIG. 1, conventionally has a case 2 delimiting one or more flow ducts in which an air flow that is accelerated by the moving elements of the turbomachine circulates.

Conventionally, a turbomachine 1 has, in the flow direction of the fluids in the turbomachine, a fan 3, a compressor 4, a combustion chamber 5, a turbine 6 and an exhaust 7.

Some turbomachines, such as the example illustrated in FIG. 1, have two turbines and two compressors working at different pressures, and therefore have a low-pressure compressor 41, a high-pressure compressor 42 and, downstream of the combustion chamber 5, a high-pressure turbine 61 and a low-pressure turbine 62.

The compressors 4 operate differently depending on the mode of operation of the turbomachine 1 (for example idle or full throttle). When the turbomachine 1 passes from idle mode to full throttle mode, a high-flow-rate compressed air flow must be discharged from the compressor 4 in order to avoid the risk of pumping. This is also the case during transitory flight phases, or during idle phases, or more generally when the pilot is caused to manipulate the throttle control.

In general, a bleed is taken from the air flow downstream of the high-pressure compressor 42 but such bleeding at high temperature, speed and rate of expansion generates intense noise levels and induces thermal stresses. However, an acoustic constraint of the turbomachine requires that the additional noise of the aircraft caused by the bleeding of the air flow (noise belonging to this new flow) and by its subsequent reintroduction are less than 1 EPNdB (“Effective Perceived Noise in Decibels”, i.e. the effective noise perceived in decibels).

The solutions proposed in the prior art for discharging the bleed air flow are not satisfactory in this respect.

It is known to reintroduce the flow at an ejection nozzle of the turbomachine. However, this solution acoustically degrades the turbomachine. Further, it is cumbersome to put in place because it requires the installation of large additional openings at the ejection nozzle.

Another known solution consists in reintroducing the air flow into a secondary duct of the turbomachine. However, this implies introducing a hot air flow into the cold flow of the secondary duct, this mixing causing a strong acoustic impact.

Turbomachines have also been proposed having an exhaust case equipped with pipes extending from the openings provided in the exhaust case, the pipes being connected to a line connecting to an opening for bleeding an air flow at the compressor.

Such a solution is however limited by the manufacturing methods conventionally used for producing these parts, generally obtained by assembling portions of untreated cast parts, and machining the functional surfaces.

The casting introduces, in particular, geometric constraints imposed on the final shape of the part, which can reduce the potential performance of the part.

Indeed, in turbofan engines, a secondary flow flows concentrically to the flow of the primary duct that passes through the compressor and turbine stages of the turbomachine.

The secondary flow flows around the compressors, turbines and exhaust case, and the elements protruding from these generate turbulence in the flow of the secondary flow.

FIG. 2 shows, for example, an exhaust case 7 comprising a mouth 8 connected to a pipe 9 configured to convey an air flow to the mouth 8 in order to reintroduce it into the flow of the primary duct at the exhaust case 7.

A flow line L of the secondary flow is also shown, and has a region of intersection I with the pipe 9, which generates disturbances in the flow of the secondary flow.

There is therefore a need to limit these disturbances and thus to improve the aerodynamic performance of the exhaust case.

### GENERAL PRESENTATION OF THE INVENTION

An object of the invention is to improve the aerodynamic performance of the solutions of the prior art.

Another object is to improve the production methods for the solutions of the prior art.

To this effect, an exhaust case is proposed for a turbomachine extending along a longitudinal axis, comprising:
an annular shroud having a wall extending axially along the longitudinal axis from a first flange, a plurality of openings being provided through the wall;
a plurality of mouths each forming a channel extending between a respective inlet and one of the openings, each mouth having:
   a docking flange at the inlet, having a radially inner edge which is in contact with the first flange of the annular shroud,
   a mouth wall comprising a radially inner wall portion which is formed by a thickened section made on the wall of the shroud.

Such an exhaust case can be radially closer to the mouth and the docking flange of the wall of the shroud, which improves the compactness of the exhaust case and improves its aerodynamic performance.

Advantageously, the invention is supplemented by the following features, taken alone or in combination:
at least one of the mouths further has a plurality of fins positioned in the channel; this can orient the bleed flow when it is reintroduced through the opening to the flow duct, which can limit the incidence between the flow and the bleed flow and thus limit the aerodynamic disturbances induced by the injection of the bleed flow; in addition, this can limit the flow penetration into the opening, which limits the risks of separation of the flow in the flow duct;
the thickened section has at least one cavity; which makes it possible to limit the mass of the exhaust case, as well as the manufacturing time when the thickened section is produced by additive manufacturing;
the first flange of the exhaust case is formed with the thickened section and has holes each shaped for the passage of a rod of an assembly screw between the first flange and a flange of a low-pressure turbine case, and at least one hole opening into a cavity which is shaped to receive an end of a rod of an assembly screw;
the thickened section is formed with a honeycomb structure; this structure offers a good compromise between mass and mechanical performance.

According to another aspect, the invention proposes a method for manufacturing an exhaust case according to the invention, wherein the mouths are produced by means of an additive manufacturing method. This makes it possible to produce geometries which would not otherwise be achievable, and to limit the quantity of materials used.

According to another aspect, the invention proposes a pressure regulation unit for a turbomachine, comprising:
an exhaust case according to the invention,
a bleed module configured to bleed a pressurised air flow upstream of the exhaust case, comprising an inlet pipe and a valve that is able to shut off, or not, the inlet pipe,
a distribution module configured to distribute the bleed flow to the mouths of the exhaust case, comprising a distribution pipe into which the inlet pipe opens, and a plurality of injection pipes each connected to the distribution pipe and respectively to one of the mouths.

According to another aspect, the invention proposes a turbomachine comprising an exhaust case according to the invention.

According to another aspect, the invention proposes an aircraft comprising a turbomachine according to the invention.

### BRIEF DESCRIPTION OF THE FIGURES

Other features and advantages of the invention will emerge from the following description, which is given purely by way of illustration and not being limiting and which should be read with reference to the attached figures, in which:

FIG. 1 is a schematic representation of a turbomachine according to the prior art;

FIG. 2 is a detailed schematic representation of a cross-section of a mouth of an exhaust case according to the prior art;

FIG. 3 is a representation of a pressure regulation unit in accordance with the invention;

FIG. 4 is a detailed schematic representation of a cross-section of a mouth of an exhaust case according to the invention.

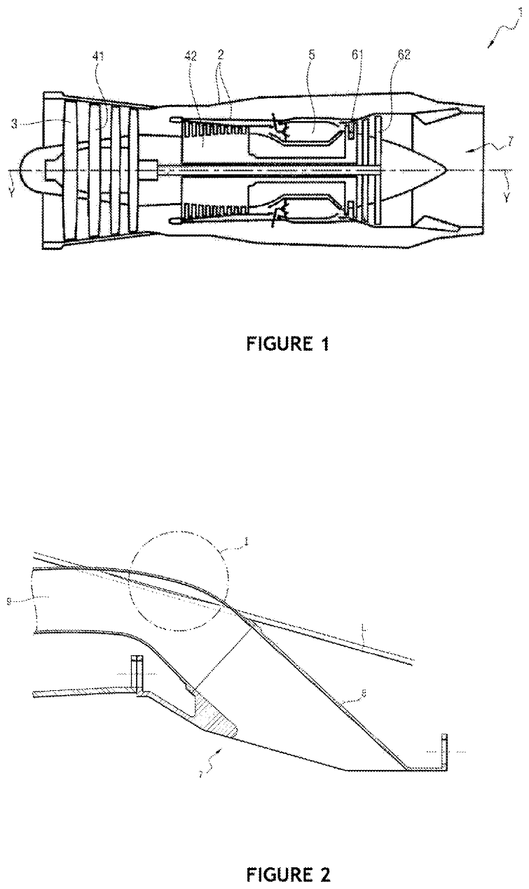

### DESCRIPTION OF ONE OR MORE EMBODIMENTS

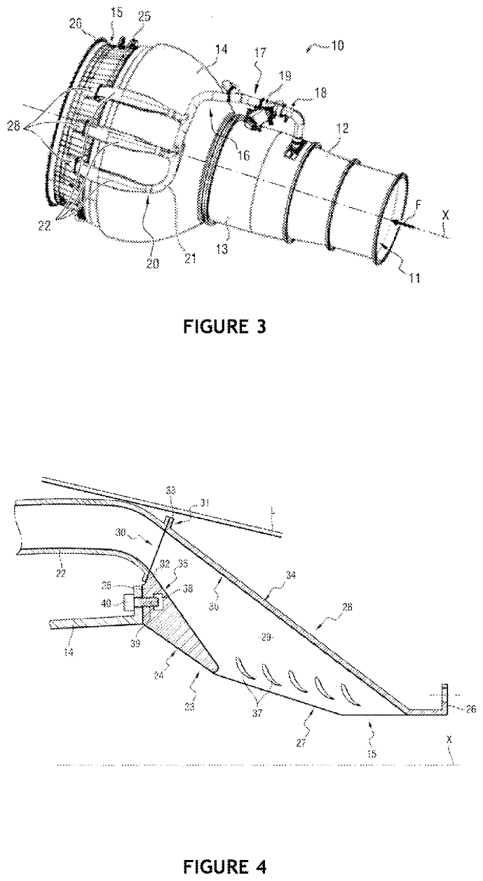

With reference to FIG. 3, a turbomachine 10 conventionally comprises, in the flow direction of the flow F in a flow duct 11 of the turbomachine 10, a high-pressure compressor 12, a high-pressure turbine 13 and a low-pressure turbine 14.

In this description, the concepts of upstream and downstream relate to the flow direction of the flow in the components of the turbomachine 10. The concepts of axial and radial relate to the cylindrical geometry with axis X along which the turbomachine extends.

The turbomachine 1 further comprises an exhaust case 15, arranged at the outlet of the low-pressure turbine 14, upstream of a discharge nozzle (not shown).

The turbomachine 10 further has a pressure regulation unit 16 configured to bleed a pressurised air flow which may, for example, be produced at the high-pressure compressor 12, and reinjecting the pressurised air flow at the exhaust case 15. In other words, the pressure regulation unit 16 produces a fluid connection parallel to the flow duct 11 and is configured to reinject the bleed flow at the exhaust case 15. Advantageously, the bleed flow is reinjected into the flow duct 11 with a Mach number less than or equal to 0.5, which can limit the acoustic impact.

The pressure regulation unit 16 comprises, in the embodiment shown:
a bleed module 17 configured to bleed the air flow in the flow duct 11, preferably downstream of the high-pressure compressor 12, the bleed module 17 comprising an inlet pipe 18 and a valve 19 able to shut off, or not, the inlet pipe 18,
a distribution module 20 configured to distribute the bleed flow to the exhaust case 15, comprising a distribution pipe 21 into which the inlet pipe 18 opens, and a plurality of injection pipes 22 connected to the distribution pipe 21.

The valve 19 can control the flow rate of the bleed air flow taken by the inlet pipe 18. The opening and closing of the valve 19 are conventionally controlled by the aircraft computer, for example depending on flight commands of the pilot.

The exhaust case 15, shown in FIGS. 3 and 4, has a substantially rotationally symmetric geometry, and comprises:
an annular shroud 23 having a wall 24 extending, from upstream to downstream, between a first flange 25 and a second flange 26 and externally radially delimiting the flow duct 11, a plurality of openings 27 being provided through the wall 24; and
a plurality of mouths 28 each forming a channel 29 extending, from upstream to downstream, between an inlet 30 and a respective opening 27, the mouths 28 being configured so as to convey the bleed flow from the inlet 30 to the opening 27.

The injection pipes 22 are thus connected to the mouths 28, which therefore makes it possible to convey the bleed air flow taken at the high-pressure compressor 12 in order to reinject it at the exhaust case 15.

Advantageously, the mouths 28 are distributed in a circle around the exhaust case 15, which makes it possible to distribute the flow reintroduced into the flow duct 11 and therefore to limit the disturbance caused by the reintroduction of the bleed flow into the flow duct 11.

Advantageously, the mouths 28 are distributed in groups which are themselves distributed around the exhaust case 15, which simplifies the structure and the installation of the distribution module 20 because it is not necessary to distribute the flow over the entire circumference of the exhaust case 15.

According to the embodiment illustrated in FIG. 3, the inlet pipe 18 opens into a distribution pipe 20 divided into two substantially symmetric sections arranged on either side of the exhaust case 15.

In the example, each of the sections of distribution pipe 20 has three injection pipes 22, each being connected to a mouth 28 of the exhaust case 15.

The exhaust case 15 therefore comprises, in this example, six symmetrically distributed holes: three holes on one side and three holes on the other. This can limit the thermomechanical distortion of the exhaust case.

Since the openings 27 do not communicate with one another, this can further improve the acoustics of the flow at the outlet of the injection pipes 22, since the air flows at the outlet of the injection pipes 22 do not mix.

Each mouth 28 has a docking flange 31 at the inlet 30, having a radially inner end 32 and a radially outer end 33, the radially inner end 32 of the docking flange 31 being in contact with the first flange 25 of the annular shroud 23. This makes it possible to avoid a flow between the first flange 25 and the docking flange 31, which would be disturbed by the obstacles and would induce turbulence. The aerodynamic performance of the exhaust case 15 is improved.

Each mouth 28 has a mouth wall 34 delimiting the channel 29 and comprising a radially inner wall portion 35 and a radially outer wall portion 36, the radially inner wall portion 35 of the mouth being formed by a thickened section made on the wall 24 of the shroud 23. This makes it possible to position the mouth 28 as close as possible radially to the wall 24 of the shroud 23, which improves the compactness of the exhaust case 15 and its aerodynamic performance.

Indeed, this makes it possible to bring the injection pipes 22 radially closer to the exhaust case 15, which can therefore limit the intersection between the injection pipes 22, the mouths 28 and the flow lines L of a secondary flow flowing concentrically to the flow F, around the high-pressure compressor 12, the high-pressure turbine 13, the low-pressure turbine 14 and the exhaust case 15. This can therefore limit the disturbances in the secondary flow, which limits the noise and improves the aerodynamic performance of the turbomachine.

The presence of an opening 27 in a non-output configuration in the flow duct 11 is similar to the presence of discontinuity or a wall which locally stops the flow in the flow duct 11 at the exhaust case 15.

The local stopping of the flow in the pressure regulation unit 16 causes an energy dissipation of the flow which is manifested by an increase in losses and a reduction in the aerodynamic performance.

In order to improve the acoustics, the mouths 28 have an inclination at their end, the slope of which is at an angle less than or equal to 45° relative to the longitudinal axis X of the turbomachine, and preferably less than 35°.

This can avoid too abrupt a break between the directions of the flow duct 11 and the channel 29 of the mouths 28. Such a break would have the effect of causing massive boundary layer separation, and consequently an increase in noise.

Advantageously, at least one of the mouths 28 has a plurality of fins 37 positioned in the channel 29, close to the opening 27, the fins 37 being configured to redirect the flow in such a way as to limit the incidence of the flow reintroduced into the flow duct 11. This can reduce the disturbances of the flow F passing through the flow duct 11 caused by the reintroduction of the bleed flow into the flow duct 11. In addition, when the pressure regulation unit 16 does not distribute flow, the fins 37 limit the tendency of the flow F to penetrate into the opening 27, and therefore limit the aerodynamic losses in the flow duct.

Advantageously, the thickened section forming the radially inner wall portion 35 of a mouth 28 can have one or more cavities 38 or voids, which can limit the mass of the exhaust case 15.

Optionally, the first flange 25 of the exhaust case 15 is formed in the thickened section and has holes 39 each shaped for, the passage of a rod of an assembly screw 40 between the first flange 25 and a flange of a tow-pressure turbine case 14. Advantageously, the holes 39 each open onto a cavity 38 which is shaped to receive one end of a rod of an assembly screw 40.

Preferably, the holes 39 are tapped in order to cooperate with a thread of the rod of the assembly screw 40 and the end of the rod is located in a cavity 38. This makes it possible to do without an assembly nut and thus to limit the mass and the number of parts of the unit, which simplifies the assembly operations.

Advantageously, the thickened section is formed with a honeycomb structure, which has good mechanical properties while strongly limiting the quantity of material required in order to form a given volume.

Such an exhaust case 15 can be manufactured by means of a method comprising assembly steps of cast elements, which are known methods, and can further comprise additive manufacturing steps. The assembly can be obtained, for example, by welding or brazing.

In an embodiment, the mouths 28 are produced by means of an additive manufacturing, or 3D printing, method. This type of method can produce complex shapes while limiting material costs. In addition, it can greatly facilitate the production of the fins 37 of the mouth 28.

This also enables production of a porous material in order to form the thickened section forming the radially inner wall portion 35 of a mouth 28. This can limit the mass of the exhaust case, limit material costs and also greatly reduce the manufacturing time of the thickened section, white retaining the mechanical properties necessary for the mechanical strength of the exhaust case dictated by its specifications.

The mouths 28 can be manufactured separately then attached and fixed on the shroud 23 by welding or brazing, or alternatively can be directly produced on the shroud 23 or a portion of shroud intended to be assembled to other shroud portions in order to form the annular shroud 23.

1. An exhaust case for a turbomachine,
the exhaust case extending along a longitudinal axis and comprising:
an annular shroud having a wall extending axially along the longitudinal axis from a first flange, a plurality of openings being provided through the wall; and
a plurality of mouths each forming a channel extending between a respective inlet and one of the openings,
each mouth having:
a docking flange at the inlet having a radially inner edge which is in contact with the first flange of the annular shroud, and
a mouth wall comprising a radially inner wall portion which is formed by a thickened section made on the wall of the shroud.

2. The exhaust case according to claim 1, wherein at least one of the mouths further has a plurality of fins in the channel.

3. The exhaust case according to claim 1, wherein the thickened section has at least one cavity.

4. The exhaust case according to claim 3, wherein the first flange of the exhaust case is formed with the thickened section and has holes each shaped for a passage of a rod of an assembly screw between the first flange and a flange of a low-pressure turbine case, and at least one hole opening into a cavity which is shaped to receive an end of a rod of an assembly screw.

5. The exhaust case according to claim 1, wherein the thickened section is formed with a honeycomb structure.

6. A method for manufacturing an exhaust case,
the method comprising:
manufacturing an exhaust case extending along a longitudinal axis, the exhaust case comprising:
an annular shroud having a wall extending axially along the longitudinal axis from a first flange, a plurality of openings being provided through the wall; and
a plurality of mouths each forming a channel extending between a respective inlet and one of the openings,
each mouth having:
a docking flange at the inlet having a radially inner edge which is in contact with the first flange of the annular shroud, and
a mouth wall comprising a radially inner wall portion which is formed by a thickened section made on the wall of the shroud; and
wherein the mouths are produced by an additive manufacturing method.

7. A pressure regulation unit for a turbomachine, the pressure regulation unit comprising:
the exhaust case according to claim 1,
a bleed module configured to bleed a pressurised air flow upstream of the exhaust case, the bleed module comprising an inlet pipe and a valve configured to shut off, the inlet pipe, and
a distribution module configured to distribute a bleed flow to the mouths of the exhaust case,
the distribution module comprising:
distribution pipe into which the inlet pipe opens, and
plurality of injection pipes each connected to the distribution pipe and respectively to one of the mouths.

8. A turbomachine comprising an exhaust case according to claim 1.

9. An aircraft comprising the turbomachine according to claim 8.

10. The exhaust case according to claim 2, wherein the thickened section has at least one cavity.

11. The exhaust case according to claim 2, wherein the thickened section is formed with a honeycomb structure.

12. A pressure regulation unit for a turbomachine, the pressure regulation unit comprising:
the exhaust case according to claim 2,
a bleed module configured to bleed a pressurised air flow upstream of the exhaust case, the bleed module comprising an inlet pipe and a valve configured to shut off the inlet pipe, and
a distribution module configured to distribute a bleed flow to the mouths of the exhaust case,
the distribution module comprising:
a distribution pipe into which the inlet pipe opens, and
a plurality of injection pipes each connected to the distribution pipe and respectively to one of the mouths.

13. A turbomachine comprising the exhaust case according to claim 2.
